(19) United States
(12) Patent Application Publication
(10) Pub. No.: US 2026/0183194 A1
(43) Pub. Date: Jul. 2, 2026

(54) Automatic drug feeding and dispensing device

(71) Applicant: Michael DEUTCH, Bene Beraq (IL)

(72) Inventor: Michael DEUTCH, Bene Beraq (IL)

(21) Appl. No.: 19/541,438

(22) Filed: Feb. 17, 2026

Related U.S. Application Data
(63) Continuation-in-part of application No. PCT/IL2024/050881, filed on Sep. 3, 2024.

(30) Foreign Application Priority Data
Sep. 4, 2023 (IL) 305669

(51) Int. Cl. A61J 7/00; A61G 12/00; A61J 1/03

(52) U.S. Cl. CPC A61J 7/0084; A61G 12/001; A61J 1/03

(57) ABSTRACT

A portable medication dispensing and administration device intended for use in a healthcare facility, equipped with an automated system for loading medications into the device and an automated system for dispensing medications.

### Related Applications

This application is a Continuation in Part of PCT Application No. PCT/IL2024/050881 having International filing date of 3 Sep. 2024, and claiming priority from an Israeli patent application No. 305669 filed on Sep. 4, 2023.

### TECHNICAL FIELD OF THE INVENTION

A portable medication dispensing and administration device intended for use in a healthcare facility, equipped with an automated system for loading medications into the device and an automated system for dispensing medications.

### BACKGROUND OF THE INVENTION

The distribution of medications to patients in healthcare facilities requires significant manpower resources. Additionally, numerous errors occur during medication distribution, resulting from mistakes in administering the correct medication at the correct time and in the correct dosage. These errors can cause severe harm to patients and, consequently, lead to high costs for healthcare systems.

The present invention provides a solution to this problem through a computerized system that manages the administration of medications to the various patients. The system identifies the patient and dispenses their specific medications, according to the prescriptions and medication administration times as they appear in the healthcare facility's computers. All of this occurs without the intervention of staff.

The system also allows for precise tracking of the number of medication items dispensed, compared to the prescriptions of patients who required that medication. This enables the determination of whether there was an error in the number of medications dispensed, as well as the number of medications remaining in the compartment containing the medication.

### PRIOR ART

Given the severity of medication errors, numerous attempts have been made to develop computerized medication dispensing devices. Some devices, such as the one described in patent JP5980125B2, are equipped with a robotic arm. These devices can dispense medications from individual containers, each containing a single type of medication, into another container based on a prescription, through computer-controlled robotic arm movements. U.S. Pat. Nos. 8,230,662B2, 5,292,029A, US20100256808A1, and US20230227261A1 describe devices that utilize a linear motion mechanism to perform the same function as the robotic arm.

In these devices, medication loading is a manual process. Medications must be manually poured into individual compartments, and the medication data must be entered along with the compartment location. When managing a large number of medications, it becomes extremely difficult to input all medication locations and data into the computer's memory. Moreover, this process is highly susceptible to errors.

Some devices use the original medication containers as the source for automated dispensing. These devices encounter a significant additional challenge: a standard ward in a hospital uses around one hundred and fifty different medications. A device that uses original containers must be very large to accommodate all the containers open and side by side, allowing the device to retrieve a medication from each.

U.S. Pat. No. 8,032,252B2 describes an automated medication loading system where the compartments are arranged around a carousel on an axis. When loading a medication into the device, the carousel rotates and positions a specific compartment under the loading opening. The computer stores the medication name and compartment location together. While intended for home use, this patent is not suitable for healthcare institutions. This is because healthcare institutions require the loading of numerous medications, and the carousel would need to be extremely large to accommodate all the compartments.

The current invention aims to provide a medication dispensing device for use in healthcare facilities of all sizes. The device will enable automated loading and dispensing of medications, reducing the likelihood of medication errors. Another objective of the invention is to provide a fully automated medication dispensing device for use in healthcare facilities of all sizes, thereby saving significant staff working hours.

The present invention provides a portable device, suitable for dispensing all the medications used in a hospital ward. A hospital ward can use more than two hundred and fifty different medications. The device is designed to accommodate a sufficient number of compartments to hold all the solid medications used in the ward. The automated medication loading system is designed with high precision, allowing for narrow compartments with minimal horizontal dimensions. This enables a device with a large number of compartments in minimal dimensions, allowing for easy mobility of the device from patient to patient. The primary volume of the compartment is in the vertical direction and is designed to hold a large quantity of medication items of the same type.

### SUMMARY OF THE INVENTION

The first aspect of the present invention comprises a device for loading and dispensing solid medications in the form of tablets, capsules, and the like. The device includes: a computer; a touchscreen; a stationary barcode scanner; a mobile barcode scanner; a loading port for inserting medications; an automated cover for the loading port that opens only after the medication is identified via barcode scanning; medication storage compartments with a small horizontal surface area, where the primary volume of the compartment is in the vertical depth, allowing for a large number of compartments in a given horizontal area; a linear motion device above the compartments; a transfer container used to receive medications from the loading port and convey the medications via the linear motion device to one of the compartments, as selected by the computer; a transfer container content release mechanism, activated when the transfer container is positioned above the selected compartment, causing the transfer container's contents to be dispensed into the compartment; a medication capture head comprising: a vertically telescoping rod, a system for raising and lowering the telescoping rod, a medication capture element at the end of the telescoping rod, and an air pump connected via a flexible tube to the medication capture element; a medication discharge area; a shelf for placing medication receiving containers; and medication receiving containers.

Another aspect of the present invention is a device for automatically loading multiple compartments, comprising a computer; a touchscreen; a stationary barcode scanner; a loading port for inserting the compartment's contents; a transfer container used to receive contents from the loading port and convey the contents via a linear motion device to one of the compartments, as selected by the computer; an automated cover for the loading port that opens only when the transfer container is positioned under the loading port; medication storage compartments with a small horizontal surface area, where the primary volume of the compartment is in the vertical depth, allowing for a large number of compartments in a given horizontal area; a linear motion device above the compartments; a transfer container content release mechanism, activated when the transfer container is positioned above the selected compartment, causing the transfer container's contents to be dispensed into the compartment.

A further aspect of the present invention is a device for loading and dispensing solid medications in the form of tablets, capsules, and the like using a robotic arm. The device includes: a computer; a touchscreen; a stationary barcode scanner; a mobile barcode scanner; a loading port for inserting medications; an automated cover for the loading port that opens only after the medication is identified via barcode scanning; medication storage compartments with a small horizontal surface area, where the primary volume of the compartment is in the vertical depth, allowing for a large number of compartments in a given horizontal area; a computer-controlled robotic arm; a transfer container used to receive medications from the loading port and convey the medications via the robotic arm to one of the compartments, as selected by the computer; a transfer container content release mechanism, activated when the transfer container is positioned above the selected compartment, causing the transfer container's contents to be dispensed into the compartment; a medication capture element at the end of the robotic arm; an air pump connected via a flexible tube to the medication capture element; a medication discharge area; a shelf for placing medication receiving containers; and medication receiving containers.

### THE DRAWINGS

FIG. 1 shows a general perspective view of a medication dispensing device.

FIG. 2 shows a detailed perspective view of a medication dispensing device.

FIGS. 3A and 3B show a perspective view of a medication dispensing device with one compartment.

FIG. 4 shows a detailed top view of a medication dispensing device.

FIG. 5 shows a detailed top view perspective of a linear motion device.

FIG. 6 shows a detailed bottom view perspective of a linear motion device.

FIG. 7 shows a detailed view of a medication capture head.

FIG. 8 shows a detailed view of a medication capture head with a telescoping rod in the open position.

FIG. 9 shows a detailed view of a medication capture head with a telescoping rod in the open position inside a compartment.

FIG. 10 shows a perspective view of a medication dispensing device with one compartment in the emptying position.

FIG. 11 shows a perspective view of a medication dispensing system with dual protection.

FIG. 12 shows a detailed view of a compartment.

FIG. 13 shows a general perspective view of a medication dispensing device with a mobile scanner and wheels.

### DETAILED DESCRIPTION OF THE INVENTION

The preferred embodiment according to the first aspect of the present invention comprises an automated medication loading system and an automated medication dispensing system.

Automated Medication Loading System: In the medication loading and dispensing device, an automated system loads medications into the device's various compartments. To open the automated cover of the loading port for medication loading, the medication's barcode is scanned using a stationary barcode scanner. Upon medication identification, a transfer container travels via a linear motion device to a position beneath the loading port. The automated cover of the loading port opens, allowing medication to be loaded into the transfer container. The computer selects an empty compartment to store the identified medication based on the scanned barcode. Subsequently, the computer closes the automated cover of the loading port and moves the transfer container above the selected compartment. The transfer container content release mechanism is activated, the transfer container's bottom cover opens above the selected compartment, and the entire contents of the transfer container are dispensed into the selected compartment. The compartment location details, and the details of the medication loaded into the compartment are automatically stored in the computer's memory.

### Automated Medication Dispensing System: in the Medication Loading and

dispensing device, the medication dispensing system includes compartments containing medications loaded via the automated medication loading system. Each compartment holds a single type of medication. The multiplicity of compartments allows for the storage of the entire standard range of medications required for a ward. To dispense medication to a patient, the patient is identified using a mobile barcode scanner or by entering the patient's details into the computer according to the healthcare facility's standard procedure. Once the patient is identified by the computer, the medication dispensing process is carried out based on the prescriptions and medication administration times associated with the identified patient in the computer's memory. The computer's memory contains information about the locations of the compartments where the medications listed in the patient's prescriptions are located. A medication capture head travels via a linear motion device towards the compartment containing the medication to be dispensed. When the telescoping rod of the medication capture head is positioned above the compartment from which the medication is to be dispensed, the telescoping rod lowering system is activated. The telescoping rod descends until the medication capture element contacts the medication. When the medication capture element contacts the medication, a switch is activated, stopping the telescoping rod lowering system. In the present embodiment, medication capture is achieved through suction. An air pump generating a vacuum is connected via a flexible tube to the tube of the medication capture element. A vacuum is created at the opening of the tube. When the tip of the medication capture element touches the medication, the medication adheres to the medication capture element via the vacuum. When the medication adheres to the medication capture element via the vacuum, a further decrease in air pressure occurs, activating a low-pressure air sensor, and the telescoping rod lowering system is activated in the opposite direction. The telescoping rod ascends, together with the medication capture element and the medication attached to it. The medication capture head travels via a linear motion device to a position above the medication discharge area. There, the air pump ceases operation, and the medication falls into the medication discharge area. A container can be placed on a shelf in the medication discharge area to receive medications falling from the medication capture element.

An additional example according to the first aspect of the present invention includes a double check for medication identification. The automated medication loading system additionally includes: a loading port container; and an automated cover for the bottom of the loading port container.

First check: To open the automated cover of the loading port for medication loading, the medication's barcode is scanned using a stationary barcode scanner. Upon medication identification, the automated cover of the loading port opens. Beneath it is a loading port container. At the bottom of the loading port container is an automated cover for the bottom of the loading port container. At this stage, medication can be poured into the loading port container.

Second check: After pouring medication into the loading port container, the medication's barcode is scanned again. If there is a match between the two scans performed, the automated cover of the loading port closes. A transfer container travels via a linear motion device to a position beneath the loading port. The automated cover of the bottom of the loading port container opens, and the medication is poured into the transfer container.

Subsequently, the computer selects an empty compartment to store the identified medication based on the scanned barcode. The computer closes the automated cover of the bottom of the loading port container and moves the transfer container above the selected compartment. The transfer container content release mechanism is activated, the transfer container's bottom cover opens above the selected compartment, and the entire contents of the transfer container are dispensed into the selected compartment. Finally, the compartment location details, and the details of the medication loaded into the compartment are automatically stored in the computer's memory.

Optional: The computer will calculate, based on existing patient data within the department and statistical data, the required quantity and type of medication for a given time period. The user will input the medication based on this calculation.

Optional: The lower portion of the medication capture element is articulated to the medication capture device via a ball joint. This allows the lower portion of the medication capture element to flex to engage the medication at the appropriate angle, ensuring optimal adhesion to the medication.

Optional: The bottom of the compartment is sloped towards one side to facilitate the gravitational flow of remaining medication towards the lower end of the slope. This allows for easy capture of the medication when the telescopic rod is lowered over the lower end of the slope, eliminating the need to search for the medication within the compartment, especially when the medication supply is low.

Optional: Each compartment has a top cover that remains closed during medication storage. The cover is opened by either opening the bottom of the transfer container when loading medication into the compartment, or by operating the telescopic rod system when removing medication from the compartment.

Optional: Customization of compartment sizes to accommodate various medication sizes. The compartment system includes compartments with varying horizontal surface areas. Larger horizontal surface area compartments are designed for larger medications, while smaller horizontal surface area compartments are designed for smaller medications. When inputting a medication, the user selects a size category from a predefined list. The computer selects the appropriate compartment based on the medication's size category, placing larger medications in larger compartments and smaller medications in smaller compartments.

Optional: For compartment emptying, an automated system is provided for collective or selective compartment emptying via the opening of the compartment bottom. A bottom cover is held closed at the bottom of the compartment by a spring. A lever is hinged to the inner wall of the compartment. A medication capture head travels via a linear motion device towards the compartment to be emptied. The telescopic rod descends into the compartment until it reaches the upper level of the lever. The telescopic rod advances along the compartment via a linear motion device and pushes the lever. The lower part of the lever pushes the bottom cover downwards, the compartment bottom opens, and all the contents of the compartment are emptied.

Optional: For collecting the contents of emptied compartments, a bottom drawer is provided. When the device is in emptying mode, excess medication is dispensed downwards. The bottom drawer is located beneath the compartments and collects all excess medication. The drawer can be pulled out and emptied as needed.

Optional: To prevent residues of previous medications in the compartments, an automated system for collective or selective compartment cleaning is provided. An air jet nozzle is attached to the medication capture device. An air pump provides the air pressure, where a reverse rotation of the air pump creates high air pressure. The air jet nozzle has a valve. When the air pump creates a vacuum, the air jet nozzle valve closes, preventing air from flowing through the air jet nozzle and maintaining the vacuum.

Optional: The air jet nozzle can be supplied with air pressure from the medical institution's air pressure system. A valve is mounted on the wall of the medication input/output device, connected internally to the air jet nozzle via a flexible tube. A tube compatible with the medical institution's air pressure system can be connected to the external side of the valve. A higher air pressure can be achieved in this way, enabling more efficient cleaning of the compartments.

Optional: For easy mobility of the device to the patient, a wheeled base is provided.

Optional: For inventory control, when inputting a medication, the number of medication units being loaded into the medication dispensing device must be entered via the touchscreen. Subsequently, the remaining number of medication units in each compartment can be obtained at any given time by subtracting the units dispensed by the device.

Optional: The computer will perform calculations based on patient data from the ward and statistical data to determine the required number and type of medication units for a given time period, and the user will input the medication based on this data.

### Technical Description

The present embodiment will be described with reference to the drawings and reference numerals for purposes of illustration only and is not intended to limit the invention to the specific embodiment shown in the drawings.

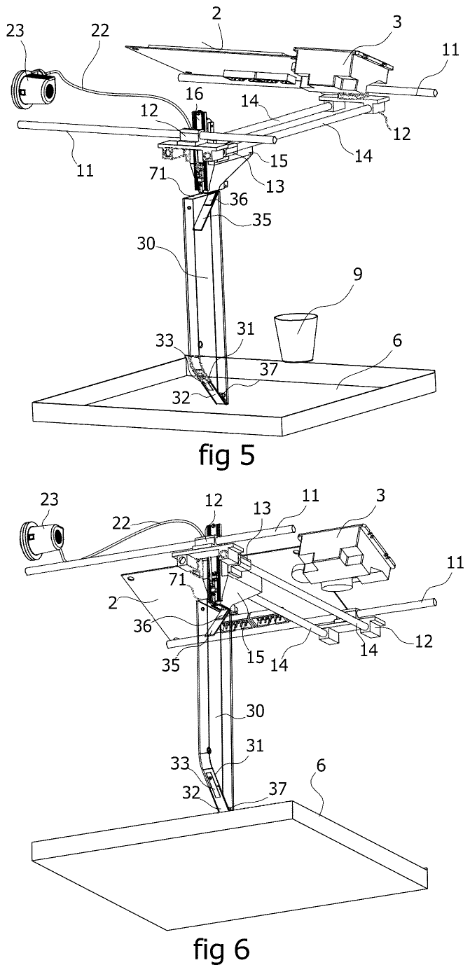

In the present example, the introduction of medications into the compartments and the removal of medications from the compartments are carried out using a linear motion device. A linear motion device (as depicted in FIGS. 5 and 6) consists of two horizontal rods 11, each of which has a horizontal conveyor 12 mounted on it. Two longitudinal rods 14 are connected between the two horizontal conveyors 12. A conveyor 13 is mounted on the longitudinal rods 14. The horizontal conveyor 12 is connected to a drive system controlled by a computer, such as a stepper motor, so that the computer, using the drive system, can position the horizontal conveyor at any point on the horizontal rods 11. Conveyor 13 is connected to a drive system controlled by a computer, such as a stepper motor, so that the computer, using the drive system, can position conveyor 13 at any point on the longitudinal rods 14. The computer can, by combining the longitudinal and transverse motion, position conveyor 12 above any of the compartments 30 in the device. Computer-controlled linear motion devices are well-known to experts in the field and are used in a wide variety of devices. For example, 3D printers commonly use a similar type of computer-controlled linear motion device.

A transfer container 15 and a medication capture head are connected to conveyor 13. The transfer container 15 is used to introduce a medication through a loading port 5 into one of the compartments 30, and the medication capture head, consisting of a telescopic rod 16 and a medication capture element 40, is used to extract a medication from one of the compartments and transfer it to a medication 8. Coordinated movement of the horizontal conveyor 12 and the longitudinal conveyor 13 brings conveyor 13, along with the transfer container 15 and the medication capture head, above any selected compartment 30.

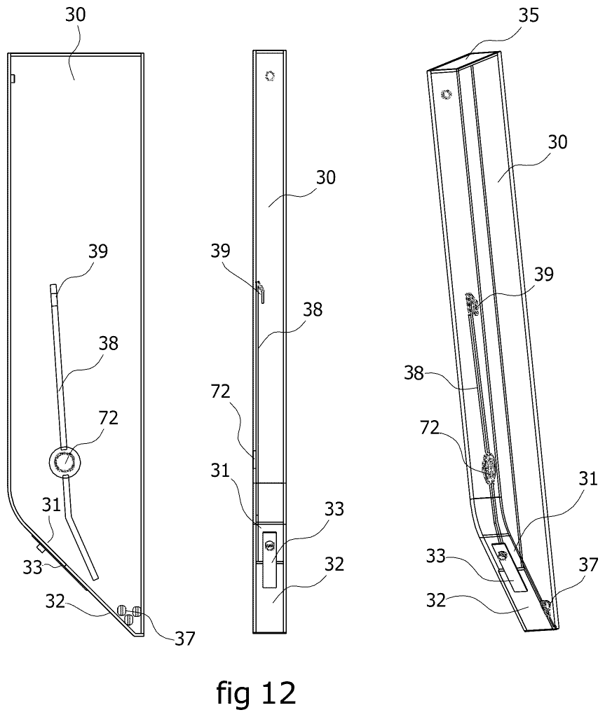

Each compartment 30 has an upper opening 71 closed by an upper cover 35 (as depicted in FIG. 12) held closed by a spring. To open the upper cover 35 when introducing a medication into compartment 30, the bottom of the transfer container 36 opens downward and pushes the upper cover 35 into the compartment (FIGS. 5, 6). To open the upper cover 35 when extracting a medication from compartment 30, the telescopic rod 16 descends and pushes the compartment cover 35 into the compartment.

In the present example, to introduce a medication into the medication loading and dispensing device, the medication barcode is scanned using a stationary scanner 3. The scan data is transferred to the computer memory. The transfer container 15, connected to the conveyor 13, travels via the linear motion device to a position beneath the feed opening 5. The feed opening cover 4 opens, and the scanned medication is poured through the feed opening 5 into the transfer container 15. The computer selects one compartment 30 and stores the selected compartment location along with the medication data to be introduced into that selected compartment in the computer memory. The transfer container 15 travels above the selected compartment 30, the transfer container content release device 19 is activated, the bottom of the transfer container 36 opens, and pushes the compartment cover 35 into the compartment, thus opening the compartment opening 71 and the medication is poured into the selected compartment 30.

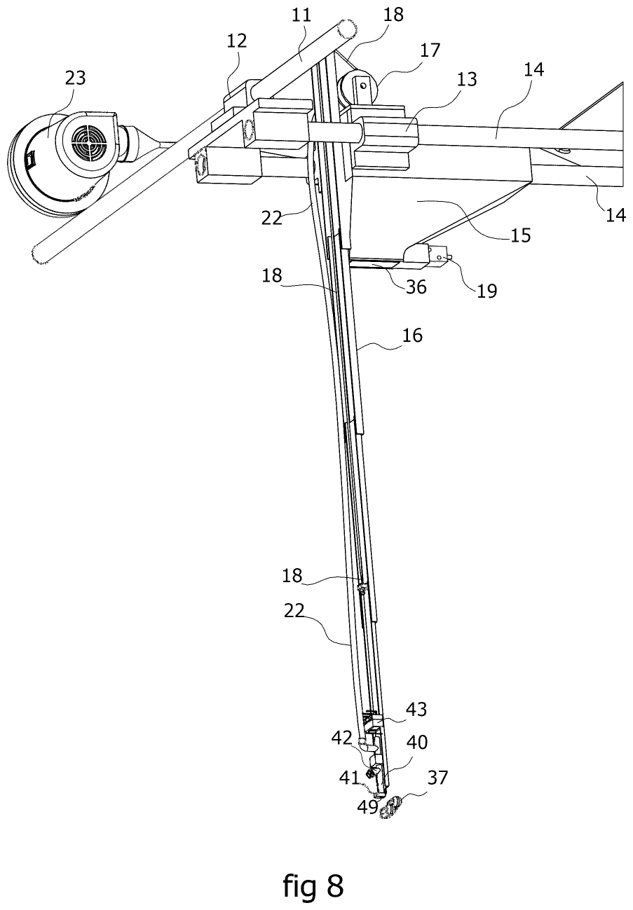

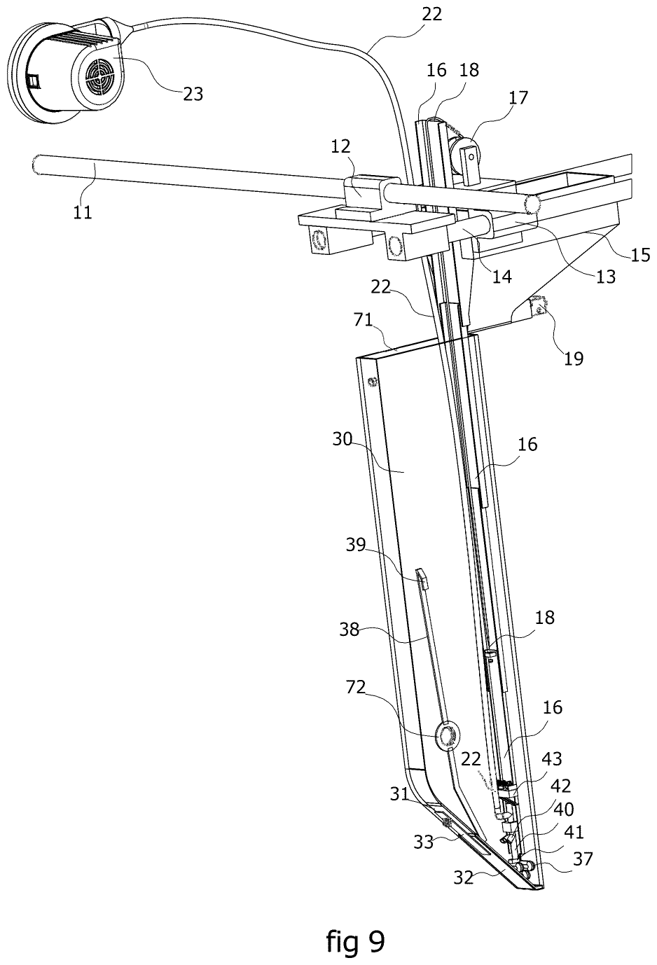

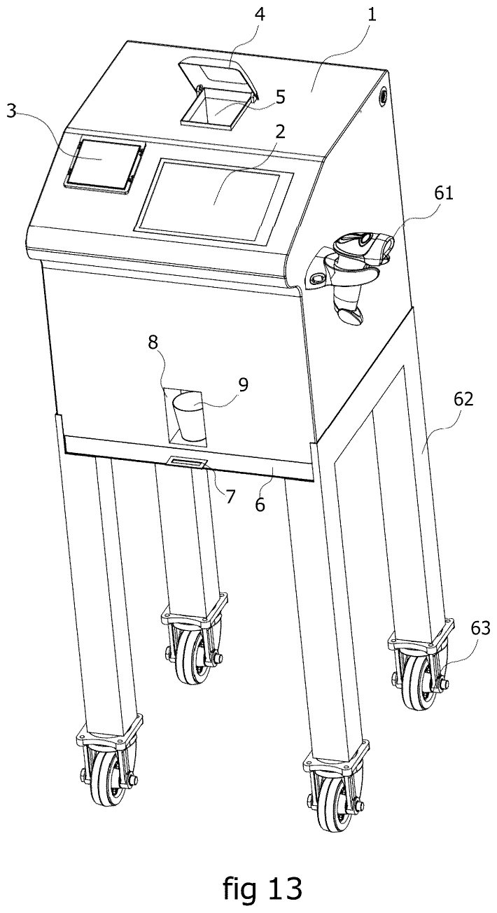

In the present example, to dispense a medication to a patient, the patient's barcode is scanned using a mobile barcode scanner 61 (as depicted in FIG. 13). The computer contains a list of all patients for whom medications are to be dispensed, and a list of all medications to be dispensed to each patient. To dispense a medication to a patient, the patient's barcode is scanned using a mobile barcode scanner 61. The computer identifies the patient and opens the list of prescriptions to be dispensed to the identified patient. The computer memory contains information on the location of each medication compartment in the medication dispensing and retrieval device. Based on the information found in the computer memory, a medication capture head connected to conveyor 13 is moved via a linear motion device above compartment 30 where the appropriate prescription medication for the patient is located. Wheel 17 rotates, cable 18 is released, and telescopic rod 16, with medication capture element 40 at its end, descends under the force of gravity, pushing the compartment cover 35 into the compartment and continuing to descend until it is stopped by contact with the medication inside the compartment (as depicted in FIGS. 8 and 9). When the medication capture element 40 is stopped by contact with the medication inside the compartment, a touch sensor 43 is pressed, wheel 17 stops, and the descent stops. An air pump 23 connected via a flexible tube 22 to the upper part of the medication capture element 40 creates a vacuum in the suction hole 49 at the end of the medication capture element 40 (FIGS. 8, 9) and one medication adheres to the suction hole 49 at the end of the medication capture element 40 (FIG. 9). To ensure that only one medication adheres to the medication capture element 40, the suction hole 49 has a minimum diameter that allows only one medication to adhere to the medication capture element 40. A soft sealing material 41 surrounds the suction hole 49, allowing for good adhesion. When a medication adheres to the medication capture element 40, a sub-atmospheric pressure sensor is activated (not shown), wheel 17 rotates in the opposite direction, cable 22 is wound around wheel 17, and the telescopic rod 16 rises. The medication capture head is moved via a linear motion device above the medication discharge area 8, the air pump 23 stops operating, the medication is released, and falls into a cup 9. The medication dispensing operation is repeated until all of the patient's prescriptions are in cup 9.

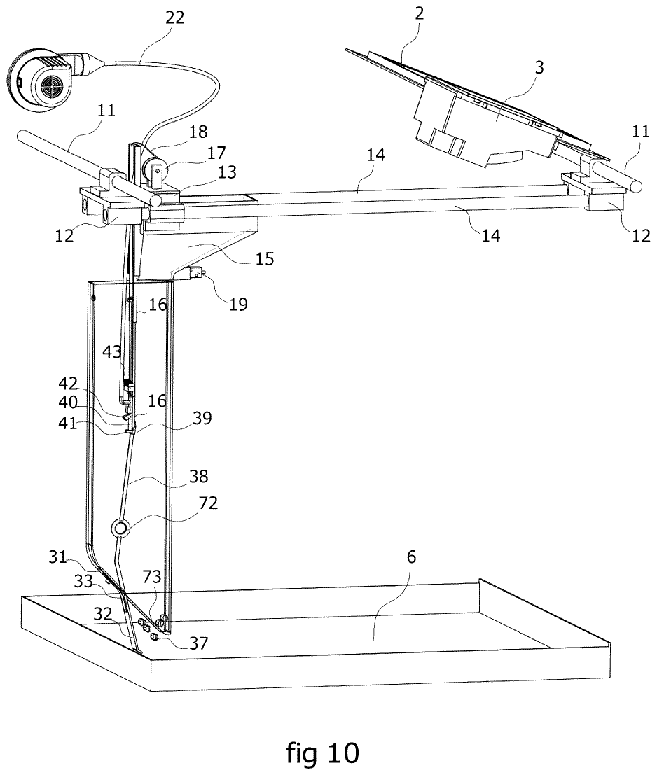

In the present example, it is possible to completely empty compartments containing a medication automatically (as depicted in FIG. 10). To release a medication from compartment 30, a medication capture head connected to conveyor 13 is moved via a linear motion device above the compartment 30 to be emptied. Wheel 17 rotates, cable 22 is released, and telescopic rod 16 descends under the force of gravity, pushing compartment cover 35 into the compartment, and continuing to descend until it is opposite the bottom compartment opening lever 38. The linear motion device moves the telescopic rod 16 along compartment 30. The telescopic rod deflects the lever handle 39 of the bottom compartment opening lever 38, and the bottom compartment opening lever 38 rotates around axis 72 and pushes the bottom compartment cover 32 downwards. Medications present in compartment 37 fall through the bottom of compartment 73 into drawer 6.

In the present example, compartments can be cleaned of residual medication using compressed air. A medication capture head connected to conveyor 13 is moved via a linear motion device above compartment 30 from which a medication is to be released. Wheel 17 rotates, cable 22 is released, and telescopic rod 16 descends under the force of gravity, pushing compartment cover 35 into the compartment, and continuing to descend until it is opposite the bottom compartment opening lever 38. The linear motion device moves the telescopic rod 16 along compartment 30. The telescopic rod deflects the lever handle 39 of the bottom compartment opening lever 38, and the bottom compartment opening lever 38 rotates around axis 72 and pushes the bottom compartment cover 32 downwards. Air pump 23 rotates in the opposite direction and creates compressed air that exits through cleaning holes 42 to clean the compartment and remove residual medication. These cleaning holes 42 have a one-way valve (not shown). When the air pump creates a vacuum, the valve closes and air cannot flow through the cleaning holes, creating a vacuum in the suction hole. When the air pump rotates in the opposite direction, compressed air is generated, the valve opens, and air flows out of the cleaning holes.

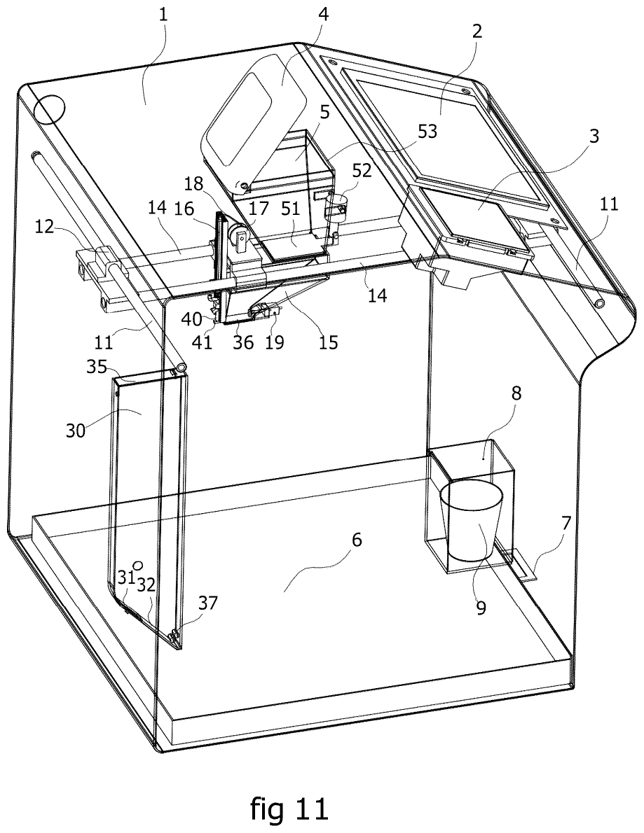

In another example, a double-check is implemented for medication identification when introducing a medication into the medication dispensing and retrieval device (as depicted in FIG. 11). First check: To open the automatic feed opening cover 4 for medication introduction, the medication barcode must be scanned using a stationary barcode scanner 3. After medication identification, the automatic feed opening cover 4 opens. Below it is a feed opening vessel 53. At the bottom of the feed opening vessel 53, there is an automatic cover for the bottom of the feed opening vessel 51. The medication is poured into the feed opening vessel 53. Second check: The medication barcode must be scanned again. If there is a match between the two scans performed, the automatic feed opening cover 4 closes, the transfer container 15 travels via a linear motion device to a position beneath the feed opening 5, the automatic cover for the bottom of the feed opening vessel 51 opens via a linear actuator 52, and the medication is poured into the transfer container 15. The computer selects an empty compartment 30 in which to store the medication identified by the scanned barcode, closes the automatic cover for the bottom of the feed opening vessel 51, and moves the transfer container 15 above the selected compartment 30. The transfer container content release device 19 is activated, the bottom cover of the transfer container 36 opens above the selected compartment 30, and all contents of the transfer container 15 are poured into the selected compartment 30. The compartment location details, and the details of the medication introduced into the compartment are automatically saved in the computer memory.

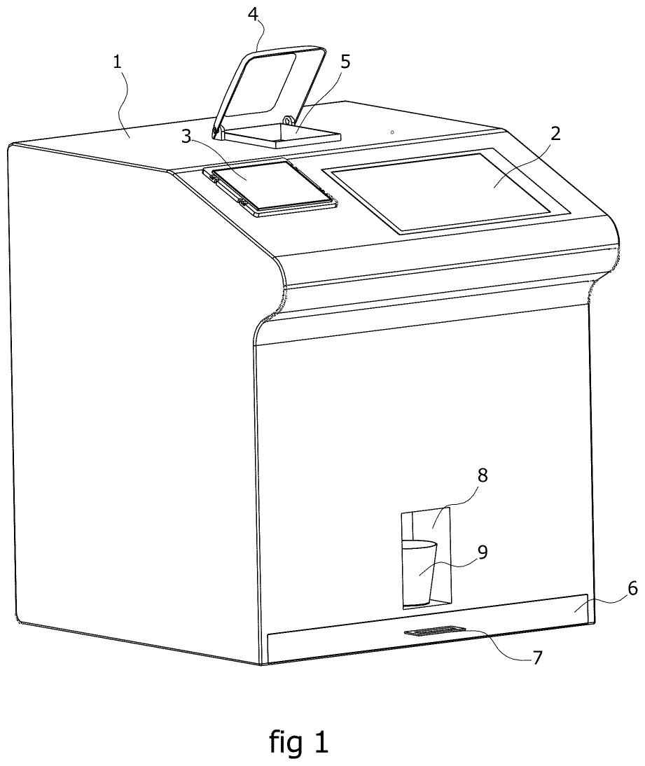

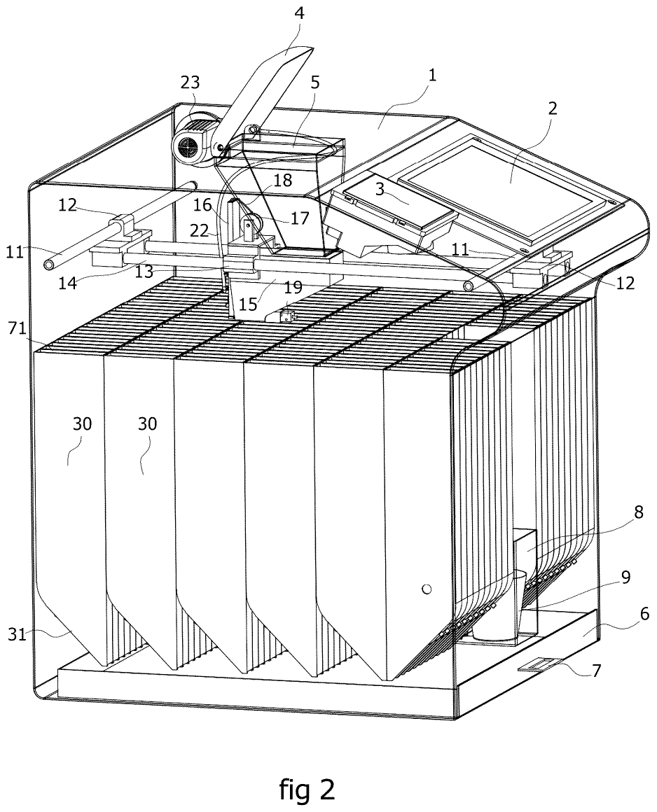

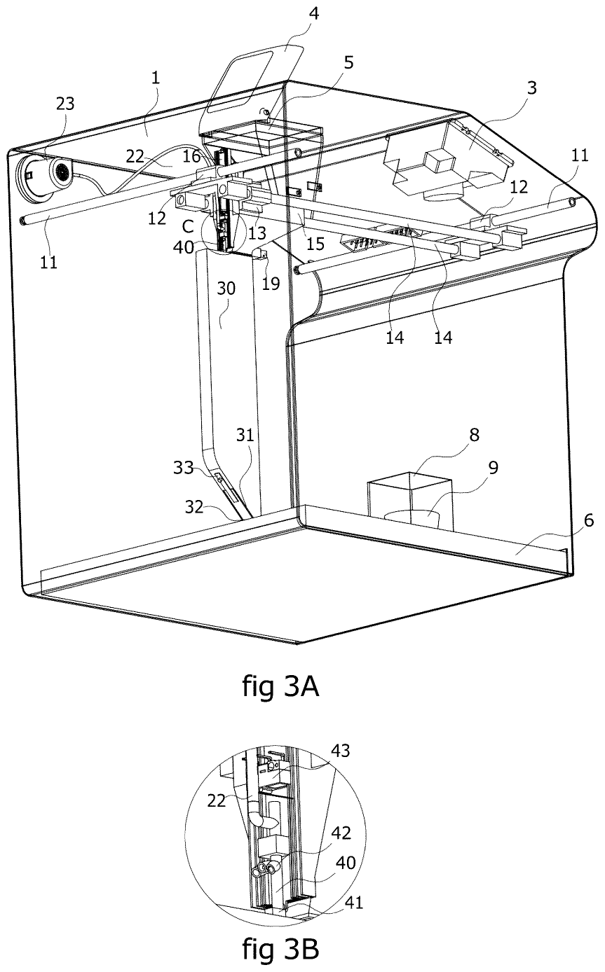

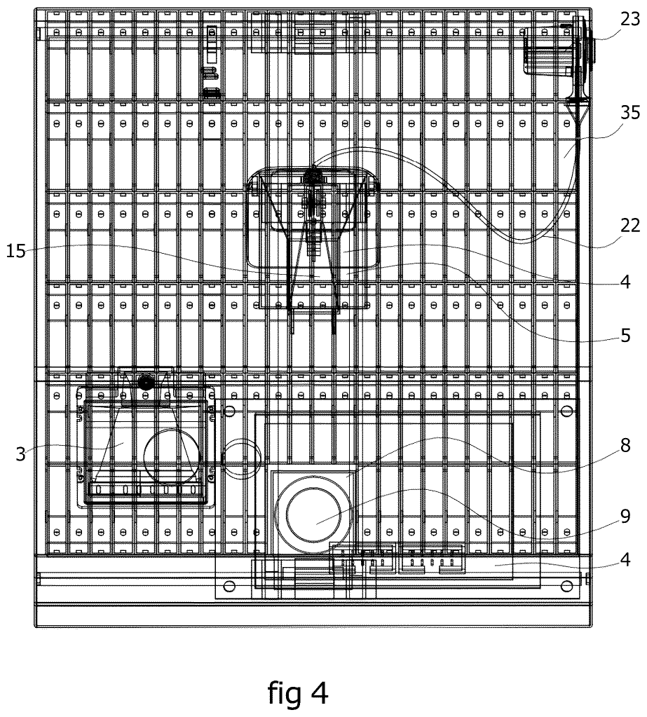

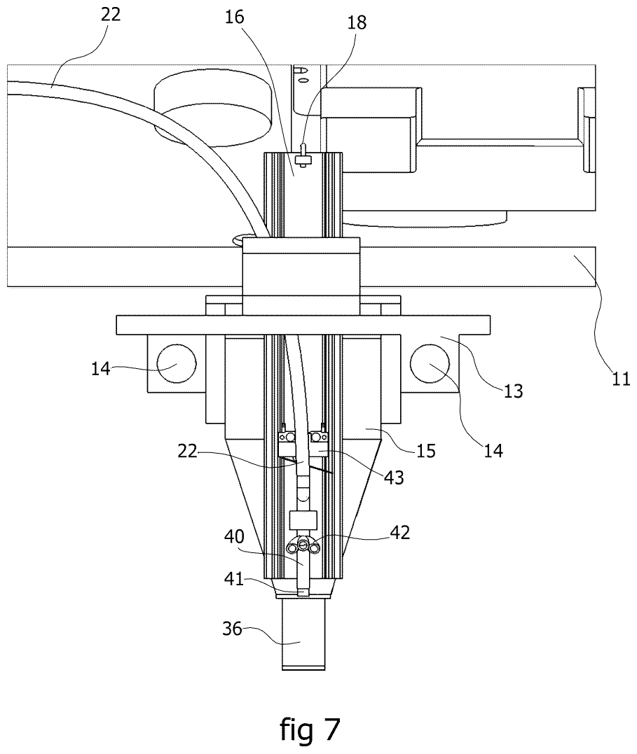

In the present example (FIG. 13), a base 62 with wheels 63 is provided for the medication dispensing and retrieval device, enabling easy mobility of the device. FIG. 1 shows a general perspective view of the medication dispensing device, FIG. 2 shows a detailed perspective view of the device, FIG. 3A sand 3B show a perspective view of the device with one compartment, FIG. 4 shows a detailed top view of the device, and FIG. 7 shows a detailed view of a medication capture head.

What we claim is:

1. A medication dispensing apparatus comprising: at least one compartment; a medication discharge area; a linear motion device positioned above the compartments;
a transfer container movable by the linear motion device; a mechanism for releasing the contents of the transfer container into a compartment; a medication capture head movable by the linear motion device; and a medication capture element extending from the medication capture head into a specific compartment for capturing at least one medication and discharging it into the medication discharge area.

2. The medication dispensing apparatus of claim 1, further comprising a system for lowering and raising the medication capture element by rotating a wheel connected to the medication capture element by a cable.

3. The medication dispensing apparatus of claim 1, further comprising an air pump for creating negative and positive air pressure, wherein the medication capture element further comprises a suction hole connected to the air pump via a flexible tube.

4. The medication dispensing apparatus of claim 1, further comprising a loading port for loading medication into the transfer container, further comprising an automatic cover for the loading port.

5. The medication dispensing apparatus of claim 1, further comprising a stationary barcode scanner, a handheld barcode scanner, and an integrated screen or touchscreen.

6. The medication dispensing apparatus of claim 1, wherein the compartments have a small horizontal surface area and the majority of the compartment volume is in the vertical depth of the compartment.

7. The medication dispensing apparatus of claim 1, wherein the compartment has a sloped bottom, wherein the compartment has an openable bottom, and wherein the compartment bottom is opened automatically by a mechanism.

8. The medication dispensing apparatus of claim 1, further comprising a removable drawer below the compartments.

9. The medication dispensing apparatus of claim 1, further comprising a system for automatically cleaning the compartment using air pressure.

10. The medication dispensing apparatus of claim 1, wherein the compartments have different sizes.

11. A medication dispensing apparatus comprising: at least one compartment; a medication discharge area; a robotic arm; a transfer container movable by the robotic arm; a mechanism for releasing the contents of the transfer container into a compartment; a medication capture head movable by the robotic arm; and a medication capture element connected to the end of the robotic arm for capturing a medication from a specific compartment and discharging it into the medication discharge area.

12. The medication dispensing apparatus of claim 11, further comprising an air pump for creating negative and positive air pressure, wherein the medication capture element further comprises a suction hole connected to the air pump via a flexible tube.

13. The medication dispensing apparatus of claim 11, further comprising a loading port for loading medication into the transfer container, further comprising an automatic cover for the loading port.

14. The medication dispensing apparatus of claim 11, further comprising a stationary barcode scanner, a handheld barcode scanner, and an integrated screen or touchscreen.

15. The medication dispensing apparatus of claim 11, wherein the compartments have a small horizontal surface area and the majority of the compartment volume is in the vertical depth of the compartment.

16. The medication dispensing apparatus of claim 11, wherein the compartment has a sloped bottom, wherein the compartment has an openable bottom, and wherein the compartment bottom is opened automatically by a mechanism.

17. The medication dispensing apparatus of claim 11, further comprising a removable drawer below the compartments.

18. The medication dispensing apparatus of claim 11, further comprising a system for automatically cleaning the compartment using air pressure.

19. The medication dispensing apparatus of claim 11, wherein the compartments have different sizes.

20. A device for automatically feeding multiple compartments comprising: at least one compartment; a linear motion device positioned above the compartments; a transfer container movable by the linear motion device; a mechanism for releasing the contents of the transfer container into a compartment, which is activated when the transfer container is positioned above the selected compartment, and the contents of the transfer container are poured into the compartment.
